(19) United States
(12) Patent Application Publication
(10) Pub. No.: US 2010/0000977 A1
(43) Pub. Date: Jan. 7, 2010

(54) METHOD FOR REMOVAL OF CONTENT-BASED STRIPE AND THE LIKE ON A SUBSTRATE AND EQUIPMENT THEREOF

(76) Inventor: ASHOK SUDHAKAR, Las Vegas, NV (US)

Correspondence Address: Nixon Peabody LLP, 200 Page Mill Road, Suite 200, Palo Alto, CA, 94306, US

(21) Appl. No.: 12/498,365

(22) Filed: Jul. 7, 2009

(30) Foreign Application Priority Data
Jul. 7, 2008 (IN) 01659/CHE/2008

(51) Int. Cl. B23K 26/00

(52) U.S. Cl. 219/121.69; 219/121.68

(57) ABSTRACT

The present invention relates to a method for removal of content based stripe and the like on a substrate. More particularly relates to a method of removal of content based stripe and the like, using lasers. The method comprising acts of generating and applying predetermined waves or pulses of the laser beams onto the determined content-based stripe and the like for removal from the substrate.

### FIELD OF THE INVENTION

The present invention relates to a method for removal of content based stripe and the like on a substrate. More particularly relates to a method of removal of content based stripe and the like, using lasers.

### BACKGROUND OF THE INVENTION AND PRIOR ARTS

This invention utilizes concepts of photonic energy transfer to achieve the end product generally achieved through the traditional methods as outlined separately. To understand the concept a very broad description of the electromagnetic spectrum leading up lasers is provided.

Electromagnetic spectrum is electromagnetic radiation classified according to the wavelength, or frequency or energy. All terms can be mathematically interchanged and are used interchangeably. The shorter the wavelength, the more energy the radiation represents. Atoms are in constant state of motion. Atoms comprise of negatively charged particles surrounding a positively charged nucleus (protons and neutrons) each electron has its own orbit (ground state). If the energy is applied to the atoms the electrons absorb it, which increases in speed and/or transitions into to a higher energy level. When the electron moves into a higher energy level it wants to return to its ground state. When it does it releases energy as a photon. Photon has zero mass and has no electric charge.

The energy of the photon depends solely on its frequency (or equivalent wavelength). Its energy (E) is defined by the equation E=C (speed of light) meters per second times Planck's constant divided by Wavelength. Plank's constant is 6.626 times 10 to the power of minus 34 joules per sec. One (1) eV=1.6 times 10 to the power of minus 19 joules.

In general, photons travelling in a wave like manner at the speed of light (299,792,458 meters per second), by contrast the speed of sound is 343 m/s that define the spectrum having long wavelength, therefore low frequency, have low energy (example: radio waves); correspondingly; photons having shorter wavelengths therefore having high frequencies have high energy (example: Gamma rays).

The focus is on the visible light spectrum and infrared spectrum and the associated wavelengths and frequencies.

In Electromagnetic spectrum Radio waves are the broadest part of the spectrum has wave lengths of 1 cm to 1 km corresponding to frequencies of 30 GHz (Giga hertz) to 100 kHz (Kilohertz.). Microwaves have wavelengths between 10 cm and 0.01 cm. Infrared radiation has smaller wavelengths and are best expressed in terms of microns (micrometers) instead of centimeters. It is one millionth of a meter or one thousandth of a millimeter. Infrared spectrum has a range of 1 to 100 microns. Infrared can be further subdivided into three sub parts: Near Infrared (IR) [closest to the visible light spectrum] defined by wavelengths ranging from 0.7-1.3 microns, middle IR has wavelengths ranging from 1.3 microns to 3 microns. Thermal IR has the largest part of the IR spectrum ranging from 3 to over 30 microns. The thermal IR is the infrared light that is emitted by an object because of changes at the atomic level.

As the wavelengths become smaller they are expressed as nanometers (it is one billionth of a meter or one millionth of a millimeter). Visible light has the range between 400-700 (nm) nanometers. As the wavelengths become even smaller and although they can be expressed in nanometers they are generally expressed in terms of photon energies. Ultra violet radiation falls between few electron volts (eV) to about 100 eV. In terms of nanometers the three divisions of ultra violet is UVA (400-315 nm); UVB (290-315 nm); UVC, closest to x-rays (below 290 nm).

Other high-energy photons are x-rays possessing energy levels in the range of 100 eV-100 keV (Kilovolts), Gamma rays photons have energy levels greater than 100 kev (100,000 eV). By way of reference Visible light spectrum photons have energy levels between 2-3 eV.

Different parts of the Electromagnetic radiation interact with matter in different ways and recognizing that the energy of a photon is solely dependent upon the wavelength is the concept in this invention.

The existing method for Stripe Removal Procedure includes steps of checking to see what type of surface and materials are to removed, completing pre-trip inspection of equipment (all fluids, grease bearings, etc), pulling truck into lane closure to get it lined up with stripe to be removed, starting up of engine that runs hydraulic system, extending grinding heads out from under truck, setting grinding heads to ready position, starting vacuum system, starting with truck moving lower grinding heads, and checking speed to make sure that stripe is removed fully.

The existing method for Markers Removal includes steps of checking to see what type of surface and what type of adhesive are o removed; scrapping markers off using a skid steer tractor if removals are Bitumen Adhesive; and sweeping to follow the marker removal to remove debris from roadway.

The existing method for removal of stripe and the like in parking lots includes steps of reviewing plans, taking measurements of parking lots, making marks for each stall and snap chalk line for layout, laying out all crosshatch areas for handicap loading area and wheel chair access, painting all blue striping firstly and then painting with white striping, installing any signage necessary in parking lot, installing concrete wheel stops when called out for in plans, taking measurements of all striping, markings, signs and wheel stops for paperwork.

The existing method for Silk Screening for signs includes steps of using a screen (which has an aluminum frame) with different sizes of mesh, adding the emulsion to the screen of aluminum frame, installing it with a squeegee from top to bottom on the inside and then cleaning the excess from the back. Here, the emulsion needs to be installed in a dark room away from light. It can only be installed with a black light and drying to have the design, placing it on the top of the exposure unit, Alternatively one can use the type with a vacuum, burning the unit and taking it to the sink to pressure wash and drying, putting on a screen exposure stand to check for any holes, printing the screen set up to line it up with the blank, putting this on top with a vacuum with a lot of ⅛^{th} holes to make suction and then printing the required signs. Finally putting them on the dry rack overnight.

The existing process of making signs by silk screening as mentioned above and another process involves adding letters cut by computer control cutters on the signage are time consuming and inefficient. The invention eliminates inefficiencies of said methods. Several steps are eliminated in manufacturing a sign. These steps such as drying, waiting for sign to dry, etc are no longer necessary.

For example, U.S. Pat. No. 4,588,885 (the patent 885') provides for a method of and apparatus for removal of paint and the like from a substrate. A method of aid appropriate for removal of paint and etc. from substrate applies to paint on airplanes and uses a complex comparison of the reflective surface to be removed and generates an electronic signal which is compared to prerecorded electronic signal representative of spectral dispersion of light reflected. Pulse energy is then applied if the is a match. The said patent 885' applies to paint on airplanes, wherein planes have to go to the apparatus. Also, the military was concerned with laser heat dissipating and possibly damaging other items.

Another example, US Patent No. 2005/0155500A1 (the patent 0155500A1') provides for a marking apparatus for printing and laser treating work piece with a pallet. The patent 0155500A1' relates to fabrics, garments. Ink is passed through selected regions to color the underlying garment.

Another example, U.S. Pat. No. 5,071,422 (the patent 442') provide for use of lasers to break down objects and more particularly uses in medical field (stones, calcified tissue) for removal from within a body down without damage to other tissues. Uses laser pulses with an optical fiber.

Another example, U.S. Pat. No. 6,144,010 (the patent 010') provide for a method of removing coating film with laser beam and laser processing system. Uses laser light to the surface coating and removing at least the upper portion of the coating through abrasion.

Another example, U.S. Pat. No. 6,384,370 (the patent 370') provides for a method of removing coating film with a laser beam.

Another example, U.S. Pat. No. 6,693,255 (the patent 255') provides for a laser ablation cleaning. The Laser cleaning apparatus is hand held cleaning head and directs laser energy to the surface to be cleaned such as corrosion.

In current practices as mentioned above the stripes are removed by abrasion using heavy-duty equipment. FIG. 1 shows the vehicle used for removal of stripes, markings in pavements and in parking lots. The grinders are installed with several head assemblies containing cutters with carbide tungsten tips. The operator using hydraulic system lowers the head assemblies until they are in contact with the surface (thermoplastic or paint) that needs to be removed. The operator then starts the motors which stats the grinding action. Thermoplastic/paint are removed and a lot of debris is generated and even with the vacuum system this operation permits debris emissions into the environment.

This invention eliminates the abrasion and associated disadvantages. Lasers replace the cutter assemblies.

### OBJECTS OF THE INVENTION

The principal object of the present invention is to develop a method for removal of content-based stripe and the like on substrate.

Yet another object of the present invention is to use laser beams for the removal of content-based stripe and the like on substrate.

### STATEMENT OF THE INVENTION

Accordingly, the invention provides for a method for removal of content-based stripe and the like on a substrate using laser beams; said method comprising acts of generating and applying predetermined waves or pulses of the laser beams onto the determined content-based stripe and the like for removal from the substrate and also provides for an equipment for removal of content-based stripe and the like on a substrate, comprising; a vehicle carrying a predetermined number of lasers; and at least one pilot laser mounted inside the vehicle ahead of said lasers, wherein said pilot laser determines effective height of laser beams onto the substrate for removal of content-based stripe and the like on the substrate.

### BRIEF DESCRIPTION OF ACCOMPANYING DRAWINGS

FIG. 1 shows the vehicle used for removal of stripes, markings in pavements and in parking lots;

FIG. 2 shows the Spectral output of several types of lasers;

FIG. 3 shows the spectrum of electromagnetic radiation;

FIGS. 4 and 5 shows examples for signage.

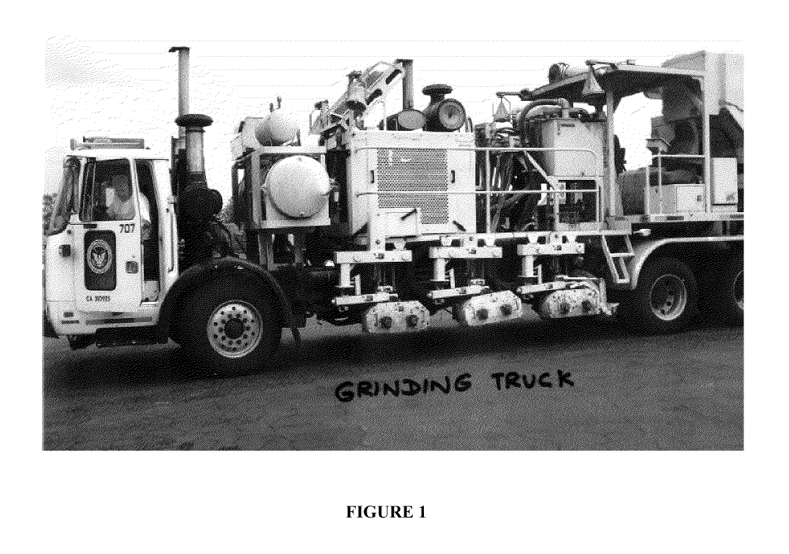

### DETAILED DESCRIPTION OF THE INVENTION

The present invention relates to a method for removal of content-based stripe and the like on a substrate using laser beams; said method comprising act of generating and applying predetermined waves or pulses of the laser beams onto the determined content-based stripe and the like for removal from the substrate.

In yet another embodiment of the present invention the lasers are portable lasers and are selected from a group comprising gas lasers, chemical lasers, dye lasers, solid state lasers, semiconductor lasers, preferably gas laser of carbon dioxide lasers, and solid state laser of NdYAG lasers.

In still another embodiment of the present invention the carbon dioxide laser emits infrared lights with a wavelength of about 10.6 micrometers and said NDYAG lasers emits infrared spectrum with wavelength of about 1.064 micrometers.

In still another embodiment of the present invention the substrate is a pavement made of asphalt and concrete.

In still another embodiment of the present invention the laser beams have energy density ranging from about 5 J/cm² to about 50 J/cm².

In still another embodiment of the present invention the laser beams have pulse repeat rate ranging from about 1 Hz to about 10,000 Hz.

In still another embodiment of the present invention the laser beams have pulse duration ranging from about 2 nanoseconds to 200 nanoseconds.

In still another embodiment of the present invention the content-based stripe and the like is selected from a group comprising a stripe & marker, parking lot stripes and signage.

In still another embodiment of the present invention the signage of predetermined shape is obtained by a method comprising acts of, coating of predetermined color onto an anodized sheet; placing of retro reflective sheet onto the coated anodized sheet; and cutting the retro reflective sheet using laser beams to obtain the predetermined signage.

In still another embodiment of the present invention the said laser beams are preferably low power pulsed lasers.

In still another embodiment of the present invention the anodized sheets are preferably made of aluminum, steel, wood, plastic, and composites.

The present invention is in relation to equipment for removal of content-based stripe and the like on a substrate, comprising; a vehicle carrying a predetermined number of lasers; and at least one pilot laser mounted inside the vehicle ahead of said lasers, wherein said pilot laser determines effective height of laser beams onto the substrate for removal of content-based stripe and the like on the substrate.

### Method for Removal of Stripes, Markers, in Existing Parking Lots, and Signage Preparation

Stripe and Marker Removal

This invention utilizes concepts of photonic energy transfer to achieve the end product generally achieved through the traditional methods as outlined separately. To understand the concept a very broad description of the electromagnetic spectrum leading up lasers is provided. Laser parameters for this invention follow the description.

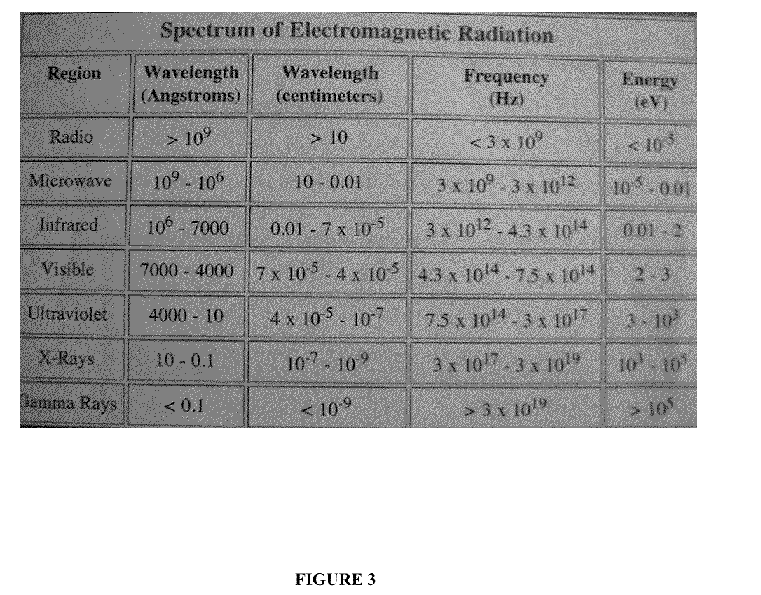

Electromagnetic spectrum is electromagnetic radiation classified according to the wavelength, or frequency or energy as shown in FIG. 3. All terms can be mathematically interchanged and are used interchangeably. The shorter the wavelength the more energy the radiation represents. Atoms are in constant state of motion. Atoms comprise of negatively charged particles surrounding a positively charged nucleus (protons and neutrons) each electron has its own orbit (ground state). If the energy is applied to the atoms the electrons absorb it, which increases in speed and/or transitions into to a higher energy level. When the electron moves into a higher energy level it wants to return to its ground state. When it does it releases energy as a photon. Photon has zero mass and has no electric charge.

The energy of the photon depends solely on its frequency (or equivalent wavelength). Its energy (E) is defined by the equation E=C (speed of light) meters per second times Planck's constant divided by Wavelength. Plank's constant is 6.626 times 10 to the power of minus 34 joules per sec. One (1) eV=1.6 times 10 to the power of minus 19 joules.

In general, photons travelling in a wave like manner at the speed of light (299,792,458 meters per second), by contrast the speed of sound is 343 m/s that define the spectrum having long wavelength, therefore low frequency, have low energy (example: radio waves); correspondingly; photons having shorter wavelengths therefore having high frequencies have high energy (example: Gamma rays).

The focus is on the visible light spectrum and infrared spectrum and the associated wavelengths and frequencies.

In Electromagnetic spectrum Radio waves are the broadest part of the spectrum has wave lengths of 1 cm (centimeter) to 1 km (kilometer) corresponding to frequencies of 30 GHz Giga hertz—to 100 kHz (Kilohertz.) Microwaves have wavelengths between 10 cm and 0.01 cm. Infrared radiation has smaller wavelengths and are best expressed in terms of microns (micrometers) instead of centimeters. It is one millionth of a meter or one thousandth of a millimeter. Infrared spectrum has a range of 1 to 100 microns. Infrared can be further subdivided into three subparts: Near Infrared (IR) [closest to the visible light spectrum] defined by wavelengths ranging from 0.7-1.3 microns, middle IR has wavelengths ranging from 1.3 microns to 3 microns. Thermal IR has the largest part of the IR spectrum ranging from 3 to over 30 microns. The thermal IR is the infrared light that is emitted by an object because of changes at the atomic level.

As the wavelengths become smaller they are expressed as nanometers (it is one billionth of a meter or one millionth of a millimeter). Visible light has the range between 400-700 (nm) nanometers. As the wavelengths become even smaller and although they can be expressed in nanometers they are generally expressed in terms of photon energies. Ultra violet radiation falls between few electron volts (eV) to about 100 eV. In terms of nanometers the three divisions of ultra violet is UVA (400-315 nm); UVB (290-315 nm); UVC, closest to x-rays (below 290 nm)

Other high-energy photons are x-rays possessing energy levels in the range of 100 eV-100 keV (Kilovolts), Gamma rays photons have energy levels greater than 100 kev (100,000 eV). By way of reference Visible light spectrum photons have energy levels between 2-3 eV.

Different parts of the Electromagnetic radiation interact with matter in different ways and recognizing that the energy of a photon is solely dependent upon the wavelength is the concept used in this invention.

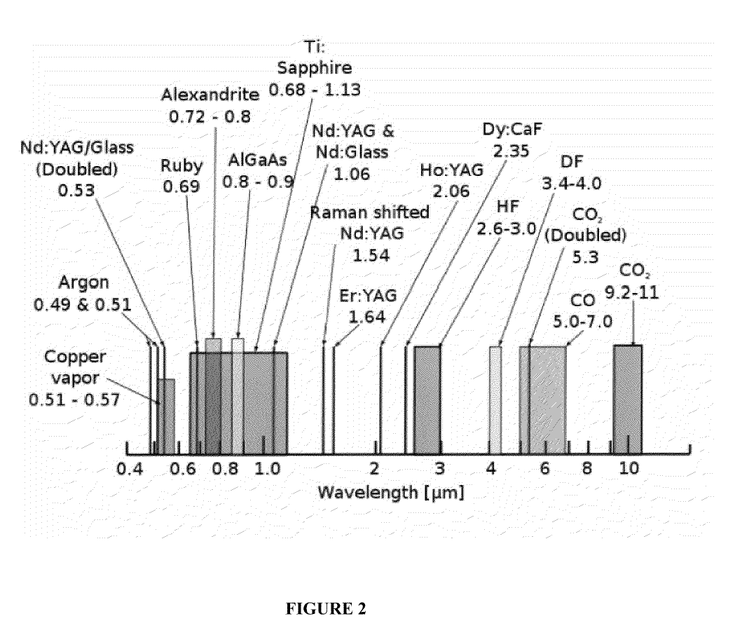

A laser is an acronym for Light (electromagnetic radiation) Amplification by Stimulated Emission of Radiation. There are many types of lasers that emit different types of wavelengths. The main types available commercially are Gas lasers, Chemical laser, Dye lasers, Solid state lasers, and Semi conductor lasers as illustrated in FIG. 2, wherein Spectral output of several types of lasers as provided.

In this invention the lasers that will be used predominantly are Carbon dioxide laser (Gas laser) emitting infrared light with a wavelength of 10.6 micrometers, Nd: YAG (Neodymium, Yttrium Aluminum Garnet) emitting in the infra red spectrum, wavelength of 1.064 micrometers (1064 nm) and with frequency doubled to emit a green beam of 532 nm, tripled for UV 355 nm and quadrupled for 266 nm UV light. Lasers can be continuous wave or pulsed.

The invention encompasses removal of varied thicknesses of materials from differing substrates.

For line stripe and markers the entire depth is required to be removed. The substrate for these items is asphalt or concrete. The thickness of the stripe varies from location to location because at times the line stripe has been striped over many times but not uniformly. The stripe is either thermoplastic or paint. The thickness of thermoplastic encountered in removal is 10 to 100-120 mil (one mil=0.001 inch=25.4 microns=0.0254 mm). The paint to be removed is generally in the range of few mil to 30-40 mil because of repainting over the stripe.

Either the road ( pavement) requires repaving (either concrete or asphalt) or if the retro reflectivity of the striping and the markers has been reduced because of weather, traffic or other damage the stripe and the markers have to be removed before new striping and markers can be installed. This invention has substantial commercial and environmental benefits.

This invention eliminates the abrasion and associated disadvantages. Lasers replace the cutter assemblies. The lasers are installed on the truck itself.

Depending upon the need as one two or three lasers will be truck mounted and each used as the need dictates. Lasers will be housed in an environmentally protected enclosure mounted on the truck. A pilot laser is also installed ahead of the removal laser (s) to determine the effective height of the laser beam to the surface. The pilot laser will provide data to on board computer that will control raising or lowering the laser (lens) to determine the optimal focal point for the laser beam on the road surface. The operator then commences the removal operations. The pulsed laser will be high power with short pulses. The laser parameters will be selected based upon the specific field conditions. The selection of the laser depends upon several parameters like the thickness of the material to be removed, the substrate, pulse rate, energy density, beam size, power of the laser, and speed of removal. Generally for finer control the energy density and pulse rate is reduced but then more pulses are required. High energy density in a very short period will vaporize the paint and thermoplastic.

For the applications in this invention the lasers have the following characteristics ranges and are increased or decreased depending upon the field conditions and need:
Energy density: 5-50 joules/cm2
Pulse repeat rate of 1-10,000 Hz
Pulse duration of 2-200 nanoseconds
All lasers used will be ANSI Z 136 compliant.

The thermoplastic and the paint will be vaporized and any fumes and minimal debris will be vacuumed. The vacuum system will have a series of filters, including a HEPA filter and a charcoal filter to remove any gases

The invention has several advantages over the prior arts:
1. No generation of substantial waste;
2. No wearable parts (cutters);
3. No uncontrolled emission from the abrasion method or sandblasting, or water blasting operations;
4. Less maintenance;
5. Better project results. In abrasion method, one 16^{th} of an inch of pavement also gets removed along with the paint/ thermoplastic as a part of the abrasion method of removal

Parking Lot Striping Removal

For adding content to the existing parking lot striping only a portion of the thickness of the stripe needs to be removed. Full depth is not required to be removed. The amount of material removed depends upon the depth to which energy is absorbed. For this application the parameters for the laser type are provided above, but the characteristics will be in the lower range. Depending upon the local conditions lower powered lasers with many short pulses will be used for this application to obtain a finer control. A computer located on an environmentally protected truck or a similar vehicle will control the laser operation. Movement of the laser beam will be controlled by a computer-preloaded content for the project/client. Post Script software like Corel Draw or Adobe will be used. The laser cut content can be filled with different color paint to provide a contrast.

The same laser process can remove the content and the stripe at the same time. A new stripe can be installed.

The thickness of the paint in parking lots is generally in the range of 5-15 mil. Retro reflectivity is not a major concern; white paint is generally used.

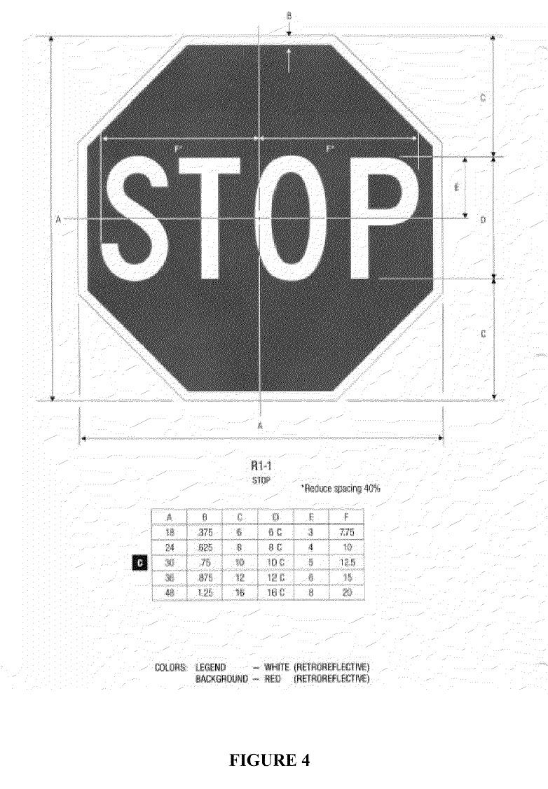

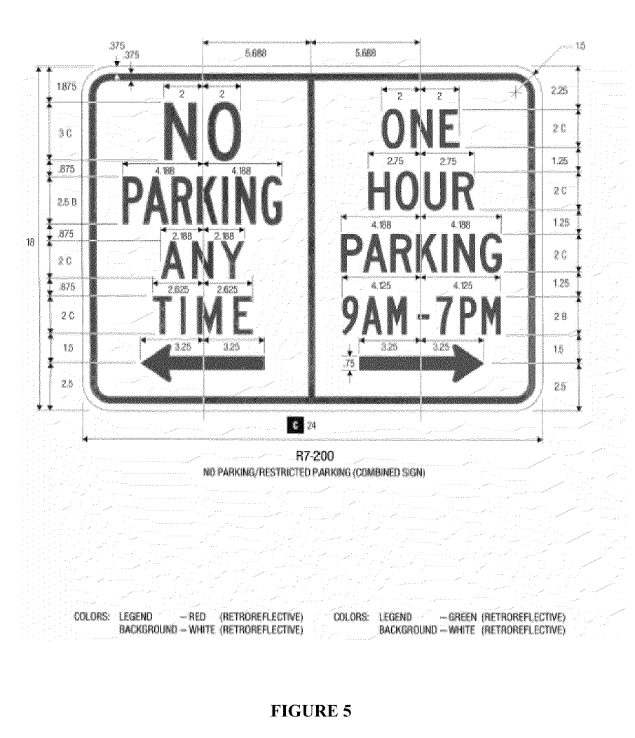

Signage (FIGS. 4 and 5)

An anodized aluminum sheet coated with the final color of lettering or art or design is taken. Retro reflective sheeting and/or anti graffiti sheeting is then placed on the top of the color coated side. Using computer system with parameters as described above will remove the retro reflective coating and or the anti graffiti. Low power pulsed laser with many short pulses will be used for this application also.

The FIG. 4 provides for an example for signage, wherein the sign of ‘STOP’ is obtained by coating of color onto an anodized sheet; placing of retro reflective sheet onto the coated anodized sheet; and cutting the retro reflective sheet using laser beams to obtain the predetermined signage.

The FIG. 5 provides for an example for signage, wherein the signs of ‘PARKING’, ‘NO PARKING’ and are obtained by coating of color onto an anodized sheet; placing of retro reflective sheet onto the coated anodized sheet; and cutting the retro reflective sheet using laser beams to obtain the predetermined signage.

The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention. The technology of the instant Application explained with the examples should not be construed to limit the scope of the invention.

We claim:

1. A method for removal of content-based stripe and the like on a substrate using laser beams; said method comprising act of generating and applying predetermined waves or pulses of the laser beams onto the determined content-based stripe and the like for removal from the substrate.

2. The method as claimed in claim 1, wherein said lasers are portable lasers and are selected from a group comprising gas lasers, chemical lasers, dye lasers, solid state lasers, semiconductor lasers, preferably gas laser of carbon dioxide lasers, and solid state laser of NdYAG lasers.

3. The method as claimed in claim 2, wherein said carbon dioxide laser emits infrared lights with a wavelength of about 10.6 micrometers and said NDYAG lasers emits infrared spectrum with wavelength of about 1.064 micrometers.

4. The method as claimed in claim 1, wherein said substrate is a pavement made of asphalt and concrete.

5. The method as claimed in claim 1, wherein said laser beams have energy density ranging from about 5 J/cm² to about 50 J/cm².

6. The method as claimed in claim 1, wherein said laser beams have pulse repeat rate ranging from about 1 Hz to about 10,000 Hz.

7. The method as claimed in claim 1, wherein said laser beams have pulse duration ranging from about 2 nanoseconds to 200 nanoseconds.

8. The method as claimed in claim 1, wherein said content-based stripe and the like is selected from a group comprising a stripe & marker, parking lot stripes and signage.

9. The method as claimed in claim 8, wherein said signage of predetermined shape is obtained by a method comprises acts of,
a. coating of predetermined color onto an anodized sheet;
b. placing of retro reflective sheet onto the coated anodized sheet; and
c. cutting the retro reflective sheet using laser beams to obtain the predetermined signage.

10. The method as claimed in claim 9, wherein said laser beams are preferably low power pulsed lasers.

11. The method as claimed in claim 9, wherein said anodized sheets are preferably made of aluminum, steel, wood, plastic, and composites.

12. An equipment for removal of content-based stripe and the like on a substrate, comprising;
a. a vehicle carrying a predetermined number of lasers; and
b. at least one pilot laser mounted inside the vehicle ahead of said lasers, wherein said pilot laser determines effective height of laser beams onto the substrate for removal of content-based stripe and the like on the substrate.
